(19) United States
(12) Patent Application Publication
(10) Pub. No.: US 2012/0254763 A1
(43) Pub. Date: Oct. 4, 2012

(54) METHODS AND SYSTEMS FOR USING AND MANAGING AGGREGATED ELECTRONIC CALENDARS IN A VEHICLE

(75) Inventors: Maria Eugenia Protopapas, Canton, MI (US); Anthony Gerald King, Ann Arbor, MI (US)

(73) Assignee: FORD GLOBAL TECHNOLOGIES, LLC, Dearborn, MI (US)

(21) Appl. No.: 13/078,355

(22) Filed: Apr. 1, 2011

(51) Int. Cl. G06F 3/00

(52) U.S. Cl. 715/738

(57) ABSTRACT

Various embodiments may include methods and systems for using and managing aggregated electronic calendars and task lists in a vehicle. The method may include receiving information at a vehicle computer identifying at least one vehicle occupant. Further, calendar data may be received at the computer including at least two electronic calendars each associated with the at least one vehicle occupant and at least one contact of the vehicle occupant. The electronic calendar for the identified vehicle occupant and the contact of the vehicle occupant may be displayed in the vehicle.

### TECHNICAL FIELD

Various embodiments relate to an electronic calendar for use in a vehicle. In some embodiments, the electronic calendar may be an aggregate of multiple calendars. The calendar items in the aggregated multiple calendars may be managed from a vehicle computing system.

### BACKGROUND

It is not uncommon for a person to use an electronic calendar to manage schedules and tasks. Various examples of schedule and task management tools using an electronic calendar are known.

For example, U.S. Publication No. 2010/0136944 to Taylor et al. discloses a method and system for performing a task upon detection of a vehicle trigger. A triggering event causes a telematics device to transmit information to a user device. Alternatively, the telematics device may perform a task in response to determining that a trigger event occurred. The user device generates an alert in response to the transmitted information producing the alert, for example, graphically, audibly, textually, or using a combination thereof. A triggering event may be the attaining of a certain location of the telematics control unit along a predetermined commute route. Alternatively, the detection of force exerted on a vehicle, possibly indicating attempted theft of the vehicle. Upon the triggering event occurring, the telematics control unit can formulate a message, for example calculate time of arrival based on the traffic conditions and speed limits along the commute route. The telematics control unit may also transmit its location information to another device, such as the user device, or a device coupled thereto, and the other device formulates the message.

As another example, U.S. Publication No. 2008/0086455 to Meisels et al. discloses communicating appointment and/or mapping information among a calendar application and a navigation application. In particular, a method for providing directions to an appointment location appearing in a calendar application includes identifying an appointment in a calendar application, determining a geographic location of the appointment, identifying another geographic location associated with a user of the calendar application, generating directions between the geographic location of the appointment and the geographic location of the other location, and providing the directions generated to the user.

As another example, U.S. Publication No. 2006/0058948 to Blass et al. discloses a recordable location-based reminder system organizer. In particular, an organization system using location information, possibly in conjunction with time based information for tasks, optimizes user travel distance and/or time to complete specified tasks. Task organization may include alternate criteria such as importance, or sharing and assigning of tasks over groups to optimize in terms of the time/location/schedule of other members of the group. The mobile system may alert users of some tasks based on the user proximity to those tasks, alert of other tasks based on both time and location, or others based solely on the current time and the time of the task. The system can provide a dynamic schedule, changing based on time estimates of the user tasks as well as actual time to complete user tasks, estimates of travel time between tasks, as well as other criteria.

### SUMMARY

One aspect includes a computer-implemented method for using and managing an electronic calendar in a vehicle. The method may include receiving information at a vehicle computer identifying at least one vehicle occupant. Further, the method may include receiving electronic calendar data at a computer including at least two electronic calendars each associated with (1) the at least one vehicle occupant and (2) at least one contact of the at least one vehicle occupant. Further, the method may include displaying the electronic calendar in the vehicle for the identified vehicle occupant and the contact of the vehicle occupant.

In some embodiments, the method may further include displaying the electronic calendar for the vehicle occupant in a first window and the electronic calendar for the contact of the vehicle occupant in a second window. The first and second windows may be aggregated in an aggregated electronic calendar.

Another aspect may include a system for using and managing an electronic calendar in a vehicle. The system may include at least one vehicle computer which may be configured to receive electronic calendar data including at least two electronic calendars, at least one of which is associated with at least one vehicle occupant. The at least one vehicle computer may be further configured to receive instructions to perform one or more calendar operations. These calendar operations may include, but are not limited to, adding, deleting, or revising one or more calendar items of at least one of the at least two electronic calendars. Further, the at least one vehicle computer may be configured to receive information identifying for which electronic calendars to perform the calendar operations. Further, the at least one vehicle computer may be configured to perform the calendar operations on the one or more calendar items of at least one of the at least two electronic calendars.

Another aspect includes a computer-program product on a computer-readable medium programmed for using and managing an electronic calendar in a vehicle. The computer program product may include instructions for receiving information identifying a vehicle occupant. Additional instructions may include receiving electronic calendar data for at least two electronic calendars. At least one calendar is associated with the identified vehicle occupant. Further included may be instructions for outputting the at least two electronic calendars at a vehicle computer.

These and other aspects will be better understood in view of the attached drawings and following detailed description of the invention.

### BRIEF DESCRIPTION OF THE DRAWINGS

The figures identified below are illustrative of some embodiments of the invention. The figures are not intended to be limiting of the invention recited in the appended claims. The embodiments, both as to their organization and manner of operation, together with further object and advantages thereof, may best be understood with reference to the following description, taken in connection with the accompanying drawings, in which:

FIG. 1 is a block topology of a vehicle computing system;

FIG. 2 is a block topology of a schedule and task management system for a vehicle;

FIGS. 3A, 3B AND 3C illustrate various embodiments of the data flow within the schedule and task management system;

FIG. 4A is a block diagram of a user registration process;

FIG. 4B is a block diagram representing a non-limiting aspect of the schedule and task management process relating to identifying a vehicle user having one or more calendars;

FIG. 4C is a block diagram representing a process for defining use and presentation preferences;

FIG. 5 is a block diagram representing another non-limiting aspect of the schedule and task management process relating to creating and/or modifying a calendar and/or task list in a vehicle;

FIG. 6 is a block diagram that illustrates another non-limiting aspect of the schedule and task management process relating to its operation in a vehicle;

FIG. 7 is a block diagram illustrating another non-limiting aspect of the schedule and task management process relating to event and/task modification in a vehicle;

FIG. 8 is a block diagram illustrating another non-limiting aspect of the schedule and task management process relating to schedule conflict notification in a vehicle;

FIG. 9 is a non-limiting representation of an aggregated calendar displayed to a user in a vehicle.

### DETAILED DESCRIPTION

Efforts to balance a personal life with a professional life is increasingly becoming more challenging. For example, a husband and wife whose respective full-time employment requires regular traveling may find it difficult to arrange time for each other. Challenges can even arise in the work world. For example, co-workers in different time zones may find it difficult to arrange mutually convenient meeting times.

Managing schedules when traveling in a vehicle adds additional complexity to an already vexing problem. For example, last minutes changes or delays may be difficult to communicate to other attendees of the meeting while traveling in a vehicle.

Detailed embodiments of the invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

It will be appreciated that the disclosure and arrangement of the figures is non-limiting. Accordingly, the disclosure and arrangement of the figures may be modified or re-arranged to best fit a particular implementation of the various embodiments of the invention.

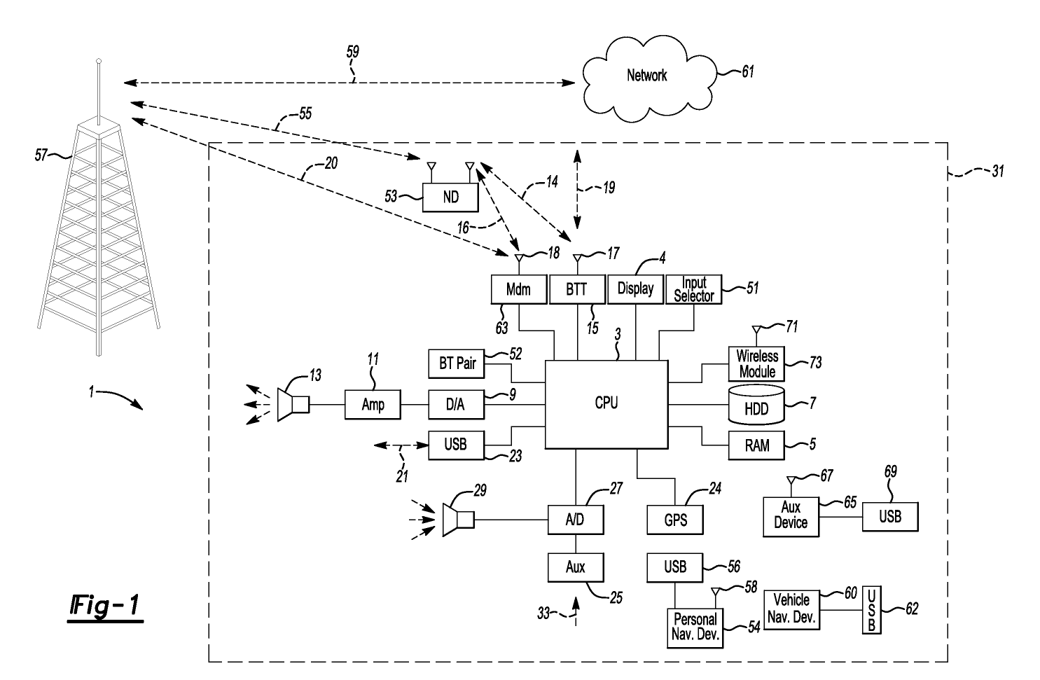

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device).

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

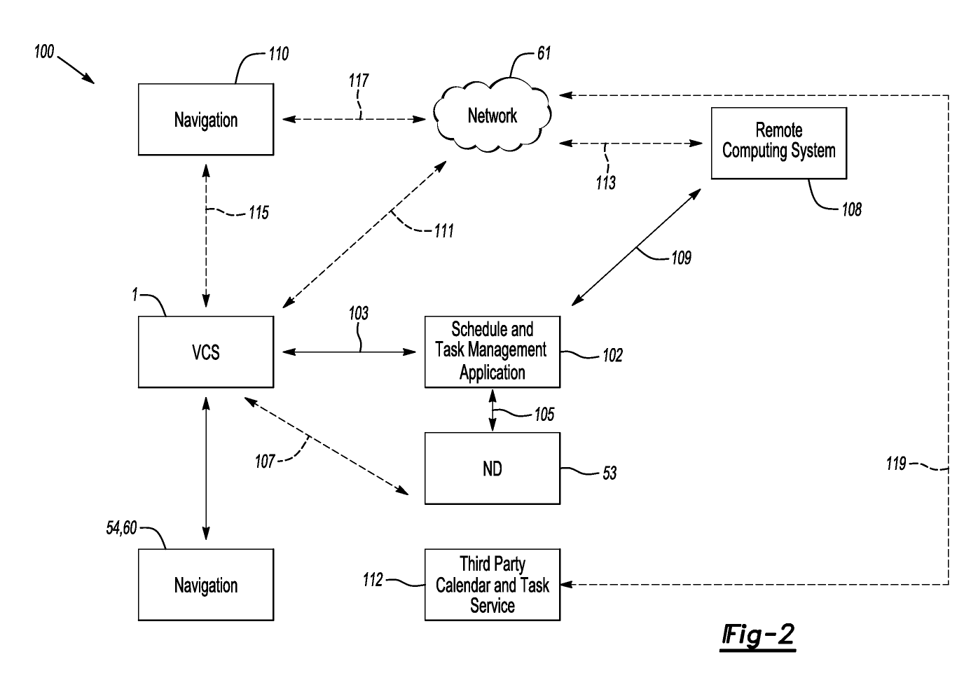

A schedule and task management system 100 for a vehicle 31 is illustrated in FIG. 2. The schedule and task management system may be used to manage multiple schedules and tasks (also referred to as “to-do” items) from the VCS 1. Managing a schedule and tasks may refer to (without limitation) viewing a schedule (including events in the schedule) and tasks, adding and deleting events and/or tasks, postponing events and/or tasks, modifying events and/or tasks, contacting event attendees (e.g., via a mode of telecommunications including, but not limited to, electronic mail, a phone call, and text message) and the like. Multiple schedules and/or tasks may refer to (without limitation) multiple calendars and/or “to-do” lists for an individual (e.g., the vehicle driver) or calendars and/or “to-do” lists for multiple individuals (e.g., the vehicle driver and other individuals such as co-workers, family members, friends, and the like).

As shown in FIG. 2, a schedule and task management software application 102 may be installed and execute on different computing systems which may individually or in combination comprise the system 100. In one embodiment, the software application 102 may execute on the VCS 1 as represented by arrow 103. The software application 102 may be downloaded or provisioned to the VCS 1 at the factory, at the dealership, or after acquisition of the vehicle. The application may be downloaded using a network connection (such as, and without limitation, the Internet). Additionally or alternatively, the application may be downloaded to a computer-readable medium (e.g., and without limitation, a DVD, USB flash drive or memory stick) and loaded to the VCS 1 from the medium. Alternatively, the application may be provisioned directly (using a wired or wireless data connection) from a remote terminal to the VCS 1. Alternatively, the software may be programmed directly to the VCS 1.

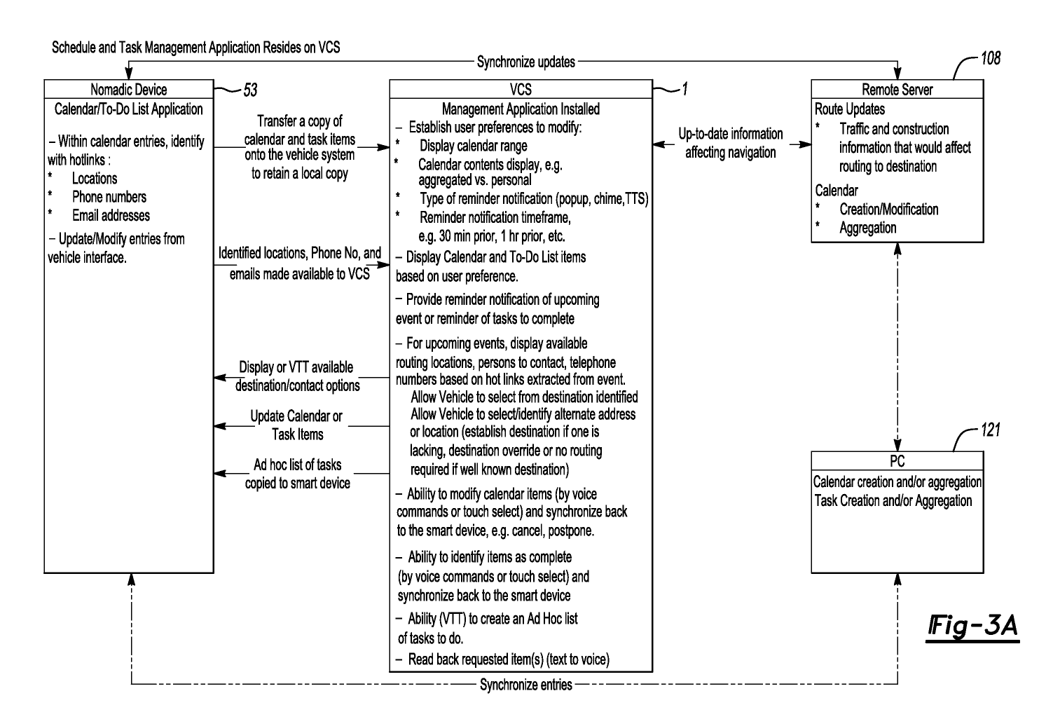

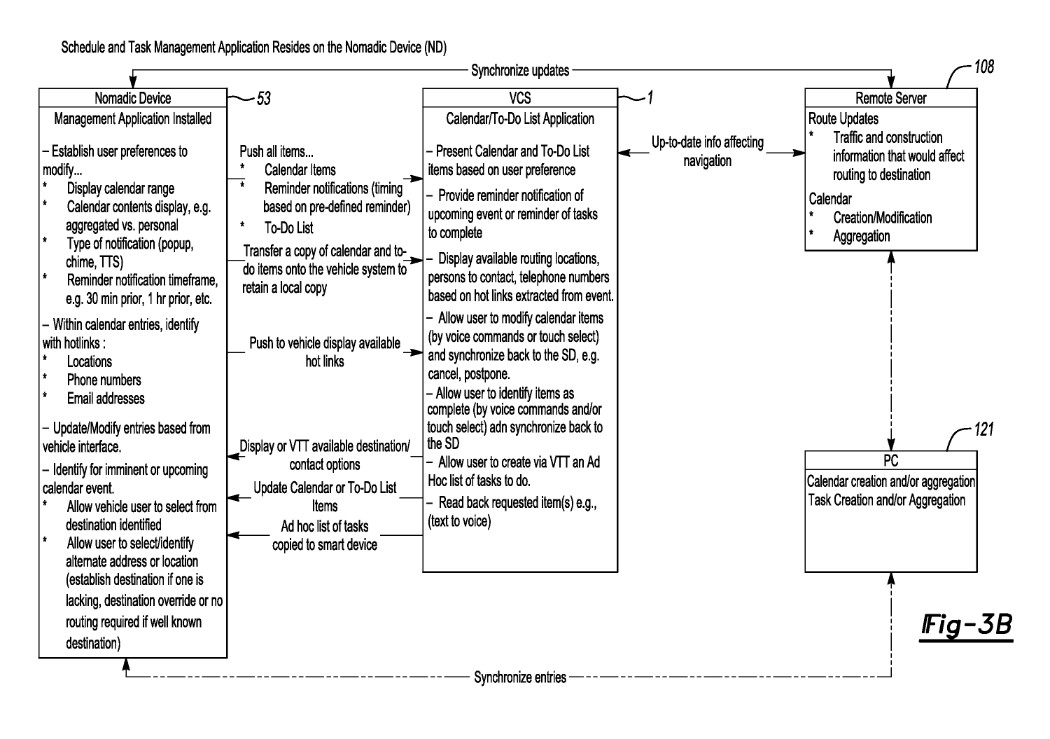

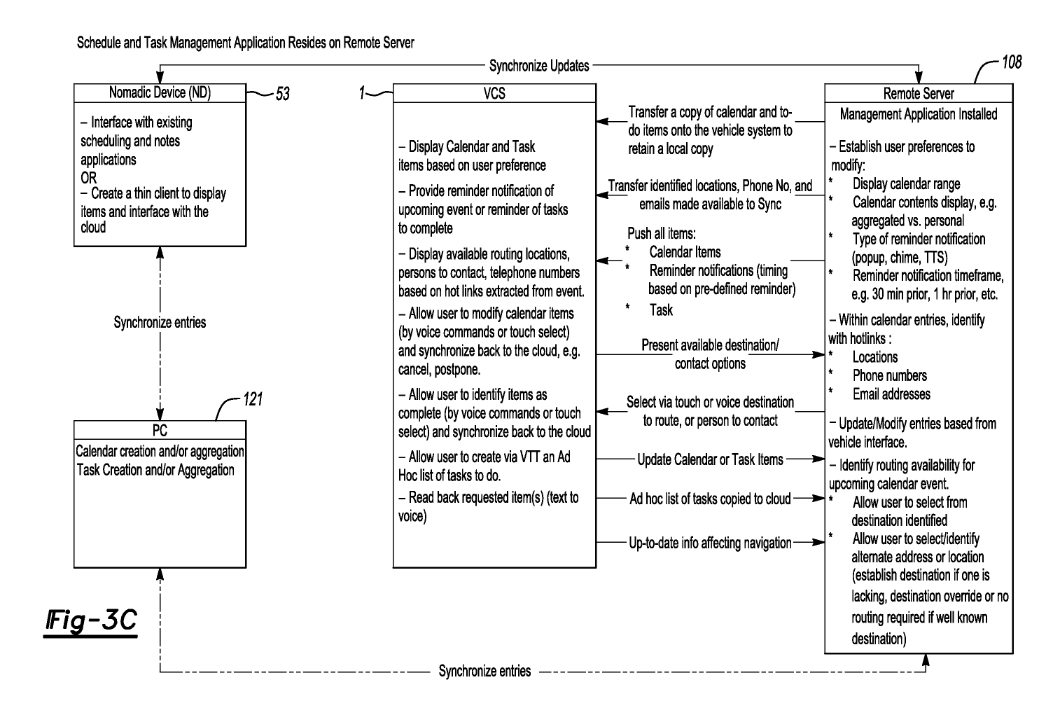

FIG. 3A illustrates a non-limiting data flow when the application 102 is installed at the VCS 1. Optionally, using a PC-based application, a calendar and/or to-do list may be created and/or aggregated at the PC 121. The calendar and/or task items on the ND 53 and PC 121 may be synchronized. Additionally or alternatively, the items on the PC 121 may be synchronized with the items on the remote server 108.

In additional or alternative embodiments, the software application 102 may run/execute on the ND 53 as represented by arrow 105. In this embodiment, the ND 53 may be in communication with the VCS 1 as described above and represented by dashed line 107 (corresponding to connections 14 and/or 16 in FIG. 1). The software application 102 may be downloaded or provisioned to the ND 53 at the dealership or after acquisition of the vehicle. The application may be downloaded using a network connection (such as, and without limitation, the Internet). Additionally or alternatively, the application may be downloaded to a computer-readable medium (e.g., and without limitation, USB flash drive or memory stick) and loaded to the ND 53 from the medium. Alternatively, the application may be provisioned directly (using a wired or wireless data connection) from a remote terminal to the ND 53.

FIG. 3B illustrates a non-limiting data flow when the application 102 is installed on the ND 53. Optionally, using a PC-based application, a calendar and/or to-do list may be created and/or aggregated at the PC 121. The calendar and/or task items on the ND 53 and PC 121 may be synchronized. Further, the items on the PC 121 may be synchronized with the items on the remote server 108.

In additional or alternative embodiments, the software application may run/execute on a computing system 108 remote from the VCS 1 or ND 53 as represented by arrow 109. As represented by dashed arrows 111 and 113, data (e.g., input and outputs) may be exchanged between the remote computing system 108 and VCS 1 and/or ND 53 through the data network (e.g., the Internet) for enabling operation of the remotely stored application 102. In this embodiment, the ND 53 and VCS 1 may be in communication as described above and represented by dashed arrow 107 (corresponding to communication 14 and/or 16 in FIG. 1).

FIG. 3C illustrates a non-limiting data flow when the application 102 is housed at a remote computing system. Optionally, using a PC-based application, a calendar and/or to-do list may be created and/or aggregated at the PC 121. The calendar and/or task items on the ND 53 and PC 121 may be synchronized. Further, the items on the PC 121 may be synchronized with the items on the remote server 108.

The VCS 1 may interface with the in-vehicle navigation device 54, 60. The navigation device 54, 60 may use navigation data (e.g., and without limitation, map data, POI data, traffic data, and the like) which may be stored locally at the VCS 1 (e.g., on a computer readable medium such as, without limitation, memory or a DVD) for providing traffic, directions, and information to a vehicle occupant. In additional or alternative embodiments, the navigation data 110 may be stored at a remote navigation computing system (e.g., separate from remote computing system 108). In some embodiments, the navigation data 110 may be stored at remote computing system 108. As represented by dashed arrows 115 and 117 (and via network 61), navigation data 110 may be exchanged with the VCS 1 from the remote navigation computing system.

The calendar and task data used by the management application 102 to manage multiple schedules and tasks may be aggregated data from a third-party calendar service 112. The calendar and tasks service 112 may aggregate multiple schedules and/or tasks of a vehicle user and/or the schedule(s) and/or task(s) of the vehicle user and others who may or may not be a user of the vehicle. As a non-limiting example, the schedules and/or tasks of each member of a family may be aggregated together. As another non-limiting example, the schedules and/or tasks of co-workers may be aggregated together. Additionally or alternatively, each family member or co-worker may have multiple personal schedules and/or tasks aggregated together. The vehicle users may be registered users of the third-party calendar and task service. Examples of third-party calendar and task services that aggregate calendar data of registered users include GOOGLE CALENDAR and MICROSOFT EXCHANGE. Third-party calendar services may also be calendar and task services from the vehicle user's employment and/or school. The data to and from the service 112 may be exchanged over data connection 119 (via network 61).

In some embodiments, the application 102 may be a calendar and/or task data aggregator. The application 102 may be provided with which other calendars and/or tasks to aggregate the vehicle user's calendar and/or tasks. As an example, the application 102 may receive a command (verbal and/or tactile) to aggregate calendar and/or task information in addition to identification information identifying with which calendars and/or tasks to aggregate the vehicle user's calendar and/or task information. The calendars and/or tasks may be identified through user identifying information such as (without limitation) a VIN, a name, or a mobile identification number (MIN). The application 102 may retrieve and aggregate the calendar and/or task information associated with the identified calendars and/or tasks. If the calendar and/or task information is located remote from the VCS 1, the calendar and/or task information may be received over network 61.

Events may be scheduled and tasks may be posted using a calendar and task application on the ND 53. Typically, mobile phone, PDAs, media devices (such as MP3 players), and other like NDs are preloaded with such applications from the manufacturer of the ND. In this case, the VCS 1 and the ND 53 may communicate via connection 107 for exchanging calendar and/or task data. In some embodiments, the third party service 112 may be used to store calendar events and tasks. The VCS 1 and the third-party service 112 may exchange calendar and/or task data (via network 61) as represented by dashed arrow 119. Additionally or alternatively, the calendar and/or task data may be exchanged via an intermediary device such as ND 53. In some embodiments, the calendar and/or task information may be stored at the VCS 1 and may serve as a backup of the calendar and/or task information on the ND 53 or the remote system 108.

Calendar(s) and/or task(s) may be presented in a vehicle 31 based on which vehicle occupant(s) (driver and/or passenger(s)) are in the vehicle 31. Accordingly, the calendar and/or tasks of the identified vehicle user (whether driver or passenger) may be presented along with the aggregated calendar information. The calendar and/or task information that is presented in the vehicle may change based on the identified vehicle user.

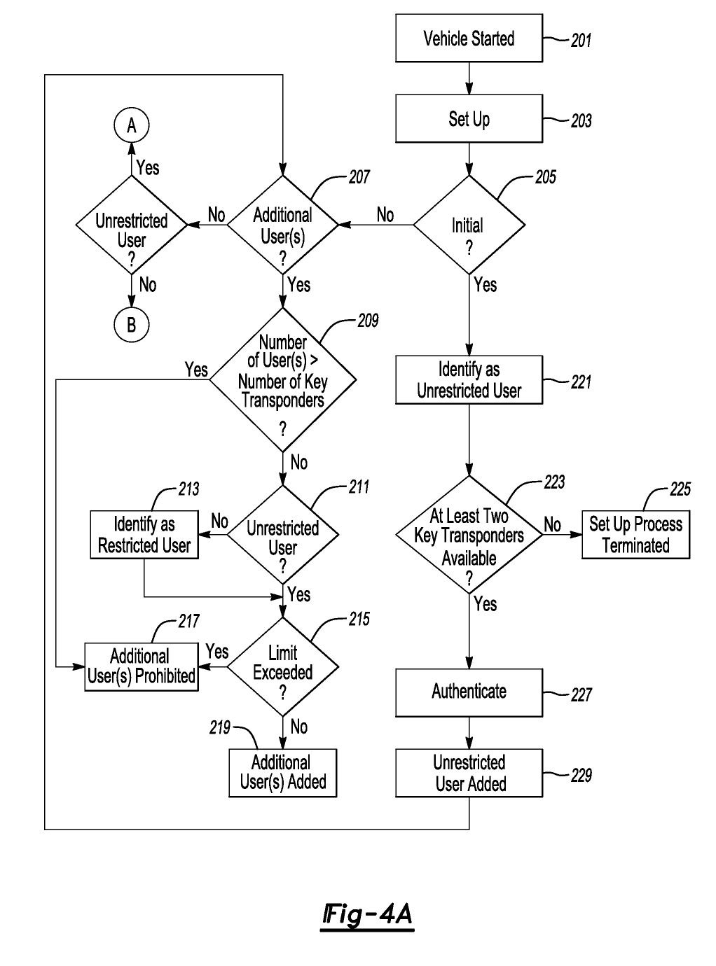

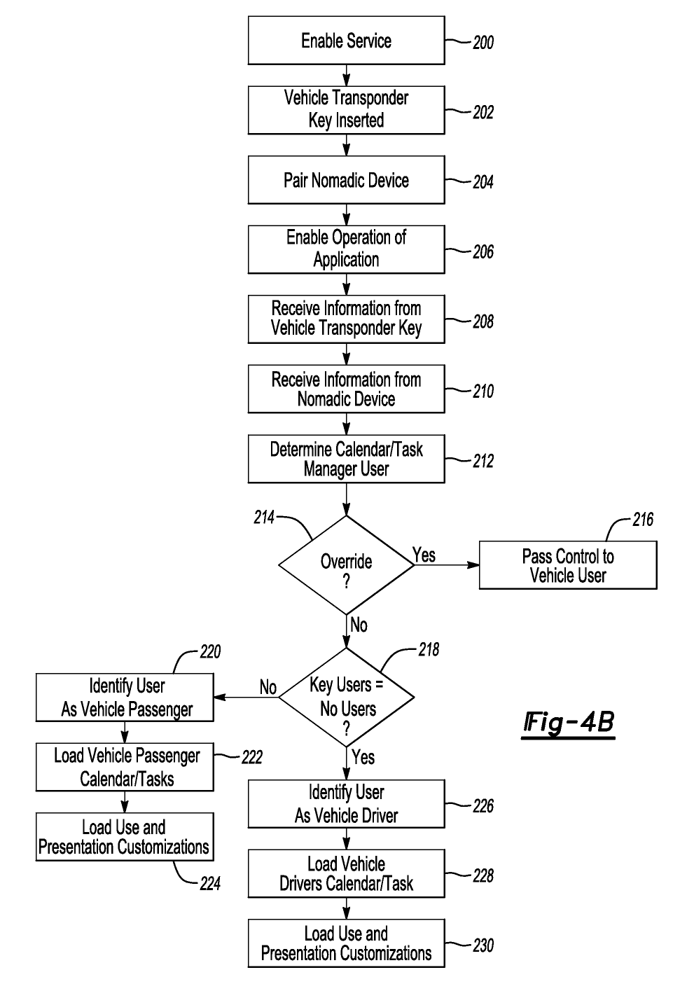

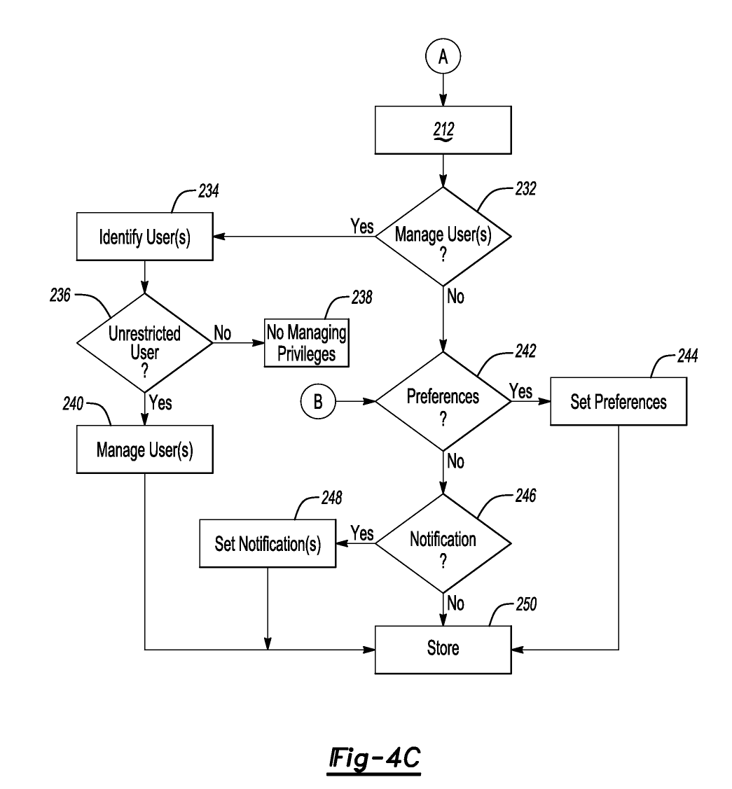

FIG. 4A illustrates a process for registering vehicle users. The vehicle users may be set up by one or more users having unrestricted use privileges, such as an administrator or one or more parents. As illustrated in block 201, the vehicle may be started (block 201) in order to perform the set up (block 203). Of course, starting the vehicle does not necessarily mean the engine is running. It may be that the vehicle is in “ACC” mode.

If the set-up is an initial set-up (block 205), an identification process may be performed in order to identify the user as an unrestricted user (block 221). In some embodiments, this identification process may include verifying that at least two vehicle key transponders are present in the vehicle (block 223). A transceiver in the vehicle may monitor for the presence of the at least two key transponders. If the key transponders are not present, the set-up process may be terminated (block 225).

However, if the key transponders are present, the unrestricted user may be authenticated (block 227) and the unrestricted user added as a user (block 229). In some embodiments, the authentication process may include verifying identification information stored on the key transponders. This verification may occur locally (e.g., at the vehicle) or remotely (e.g., at a remote computing system via a network connection).

Anytime, an unrestricted user may seek to add additional users (block 207). These additional users may also be vehicle users. In some embodiments, a check may be in place to verify that the user adding additional users is an unrestricted user. For example, the check may be based on the authentication process described above. Additionally or alternatively, the information on the key transponder(s) may be compared with information from a paired nomadic device to determine the type of user.

If the check shows that the user is not an unrestricted user, the user may be prohibited from further operation. In some embodiments, the restricted user may be permitted to set-up preferences as represented by circle block B.

If the check shows that the user is an unrestricted user, but additional users are not added, the unrestricted user may set-up preferences as represented by circle block A. Further, unlike restricted user, the unrestricted user may manage the users as well (block 232 of FIG. 4C). Further details of this set up process with respect to restricted and unrestricted users will be described below with respect to FIG. 4C.

In some embodiments, a limit may be placed on the number of users that may be added. Accordingly, if the unrestricted user seeks to add additional users, a check may be made to verify that the limit has not been exceeded (block 209). In some embodiments, this verification may include determining if the number of users exceeds the number of key transponders. If so, the addition of user may be prohibited (block 217).

However, if additional user may be added, it may be determined, based on information provided by the unrestricted user, if additional unrestricted users are being added (block 211). If not, then the additional users may be identified as restricted users (block 213).

In some embodiments, the number of restricted and/or unrestricted users may be limited. Accordingly, a check may be made if the limit of the number of users as restricted and/or unrestricted has been exceeded (block 215). If so, the addition of additional users as restricted and/or unrestricted may be prohibited (block 217). In some embodiments, the additional of additional users may be prohibited unless one or more users are deleted.

If the limit to add users has not been exceeded, the additional users may be added (block 219).

FIG. 4B illustrates a non-limiting example of a process for presenting a vehicle user's calendar and/or tasks in a vehicle. Referring now to block 200, the service may be enabled in order to provide the schedule and task management service in the vehicle 31. Enablement may refer to provisioning the application 102 to the VCS 1, ND 53, and/or remote computing system 108, subscription to the service, payment for the service, activation of the service, or combinations of the above.

Identifying information about a vehicle user may be stored on multiple devices. For example, a vehicle transponder key may store identifying information about a vehicle driver. The identifying information may be stored on the vehicle transponder key using software and/or a web-based software program. Additionally, the ND 53 may store information identifying a vehicle user (e.g., a driver or a passenger). Identifying information associated with the vehicle user may include, but is not limited to, a mobile identification number (e.g., and without limitation, a phone number), a name, an address, or a code or algorithm associated with a vehicle occupant. The code or algorithm may include, but is not limited to, letters, numbers, symbols, characters, voice recognition, or a combination of letters, numbers, symbols, characters, and voice recognition. Further, the code or algorithm may correspond to a complementary code or algorithm stored on the VCS 1, the ND 53, the vehicle transponder key, or at a remote computing system 108.

In the vehicle 31, the vehicle transponder key may be inserted to a vehicle key port (not shown) (block 202). Additionally, the ND 53 may be paired with the VCS 1 (block 204). A non-limiting example of the pairing process is described above with respect to FIG. 1. When the application 102 is enabled (block 206), the information may be received from the transponder key (block 208) and/or the ND 53 (block 210). The application 102 may be enabled in response to one or more verbal and/or touch-sensitive commands from the vehicle user. Using the information from the transponder key and/or ND 53, the vehicle user may be identified (block 212).

In some embodiments, the system 100 may be configured with an override option permitting a vehicle user to control which calendar is presented rather than the application 102 automatically making the determination (as further described below). The override may be activated using verbal and/or touch-sensitive commands at the VCS 1. In some embodiments, an override may be perpetually active based on preferences set by the vehicle user until deactivated by the vehicle user. These preferences may be programmed to the application 102. Accordingly, if the override is activate (block 214), control may be passed to the vehicle user (block 216).

Otherwise, the vehicle user may be identified from the information received from the ND 53 and/or vehicle transponder key. In some embodiments, as illustrated (without limitation) in FIG. 4B, a determination of the vehicle user may be made based on whether the identification information in the vehicle transponder key matches the ND information (block 218). If the vehicle transponder key user is not the same as the nomadic device user based on the information in the respective devices, the user may be identified as a vehicle passenger (block 220).

The vehicle passenger's calendar and/or task information may be loaded at the VCS 1 (block 222) as an aggregated calendar having calendar and/or task information for others associated with the vehicle passenger (e.g., and without limitation, family members and/or co-workers). Additionally, the vehicle passenger's use and presentation customization may be received and loaded (block 224). These use and presentation customization may be configured and stored in memory (e.g., at the VCS 1, the remote computing system 108 and/or the ND 53) by the vehicle user (e.g., in this case, the passenger) and include preferences such as (and without limitation) manner and time for conflict notifications, calendar information presentation preferences, and communication preferences (e.g., electronic mail, text message, phone call, etc.). In some embodiments, controls on the VCS 1 may be enabled since the vehicle user is the passenger. As a non-limiting example, the vehicle passenger may interact with a touchscreen display 4 which may be disabled if the vehicle user is identified as the driver.

Referring back to block 218, if the vehicle transponder key user is the same as the nomadic device user, the vehicle user may be identified as the vehicle driver (block 226). The vehicle driver's calendar and/or task information may be loaded (block 228) along with the customizations (block 230). The customization process for the vehicle driver is described above with respect to the customization process for the vehicle passenger.

In some embodiments, the vehicle user identification process may also use a vehicle user's voice. Accordingly, one more voice commands may be used to further authenticate/identify the vehicle user.

In some embodiments, when the vehicle user is identified (as described above with respect to FIG. 4B) (block 212), the user may seek to further manage calendar use and options. FIG. 4C illustrates a non-limiting example of a further process for setting up calendar use. As described above, restricted and unrestricted users may be have different set up options.

The unrestricted user may seek to manage the one or more vehicle users (block 232). In some embodiments, the user may be identified (block 234) and a check may be made that the user is an unrestricted user (block 236). If not, the user may be prohibited from managing the users (block 238). Otherwise, once confirmed, the user may engage in user management (block 240).

User management may include adding/deleting users (as described above), allowing/disallowing additional unrestricted users, allowing/disallowing global calendar access, and enabling/disabling aggregation of all vehicle users' calendars and/or tasks. If global calendar and/or task access is disabled, restricted user may have access to their calendar(s) and calendar items made available to all users by the respective owners.

All users (whether restricted or unrestricted) may set up preferences (block 242). One non-limiting example of a preferences that may be set (block 244) may include, but is not limited to, display preferences (e.g., and without limitation, calendars to display (personal and/or aggregated), calendar themes, display range/timeframe, calendar display order, and, if there are duplicate calendars associated with the user and one or more user's aggregated contacts, from which source to display calendar items). Another non-limiting example may be synchronization preferences (e.g., synchronization frequency and devices to synchronize). Other preferences are described above.

Security controls may also be configured as part of the preferences. Such security controls may restrict access to calendar information within an aggregated calendar. For example, the vehicle user(s) (whether unrestricted or restricted) may only receive and/or have access to select information from an aggregated contact's calendar based on permissions from the aggregated contact. Non-limiting examples of such select information to which a vehicle user may have access may include, but are not limited to, access to schedule conflicts and available time/day slots.

The user(s) may also set up notification preferences (block 246). If notification preferences are set up (block 248), these may include, but are not limited to, setting notification type (e.g., audible and/or visual) and/or notification timeframe.

Once user management is complete and/or preferences set up, the information may be stored (block 250).

FIG. 9 illustrates a non-limiting example of aggregated calendar information displayed to a vehicle user (e.g., driver or passenger). As shown in FIG. 9 at tab 700, “Bill” may be the vehicle driver or passenger whose calendar information is displayed. Bill also has access to the calendar information for “Rachel” (tab 702) and “David” (tab 704). As represented by tab 706, Bill may also select “All” which may display all of the aggregated calendar information (e.g., for Bill, Rachel and David) together. It will be appreciated that the labels used in FIG. 9 are non-limiting and provided for illustration purposes. Further, the use of tabs is not limiting. The tabs may be substituted for other input controls (touch-based and/or voice and graphical and/or non-graphical) without departing from the scope of the invention. Non-limiting examples may include icons, capacitive inputs, graphical buttons, voice, and the like.

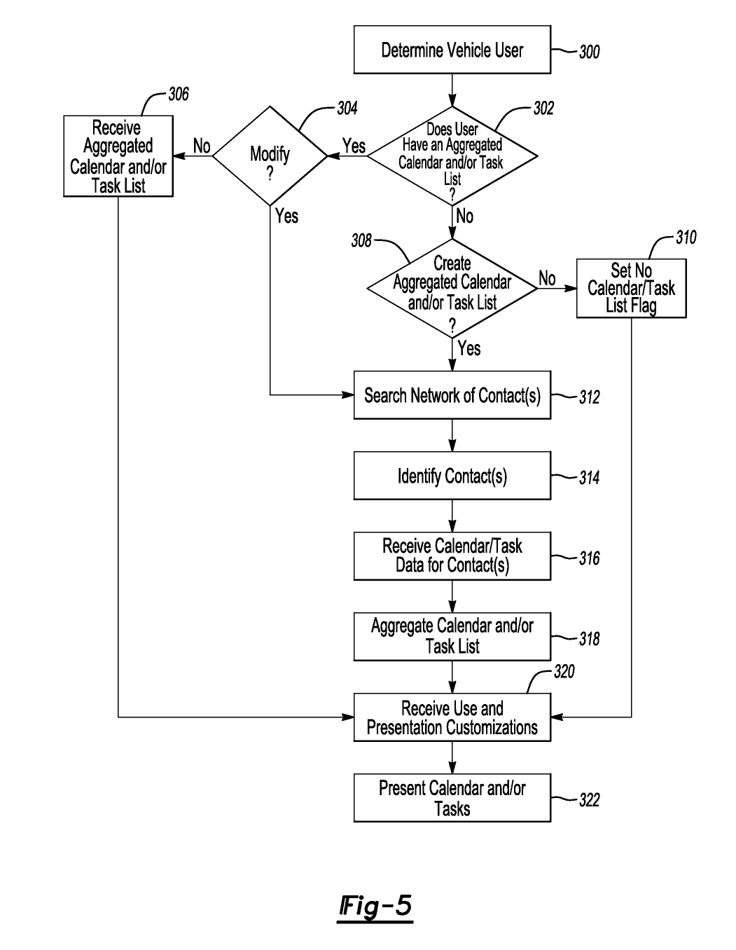

The vehicle user may create and/or modify the aggregated calendar from the VCS 1. This may be useful, as a non-limiting example, when the vehicle user seeks to add or delete an aggregated contact's calendar in the vehicle. FIG. 5 illustrates this aggregated calendar creation/modification process. As illustrated in FIG. 5, the aggregation may occur at the third-party calendar service. In some embodiments, however, the aggregation may be performed by the application 102.

As represented in block 300, the vehicle user may be identified as described above (block 300). A vehicle user may not necessarily aggregate their calendar and/or tasks with other calendars and/or tasks. Accordingly, it may be determined if the vehicle user has an aggregated calendar and/or “to-do” list (block 302). If so, the vehicle user may or may not modify the aggregated calendar and/or “to-do” list (block 304). Whether or not the aggregated calendar and/or to-do list is modified may be based on one or more commands (verbal and/or touch-sensitive) received at the VCS 1. If the vehicle user does not modify the aggregated calendar and/or to-do list, the unmodified aggregated calendar and/or to-do list may be received at the VCS 1 (block 306). The customizations configured for the vehicle user may also be received (block 320). The aggregated calendar and/or to-do list for the vehicle user may be presented in the vehicle (block 322). The calendar may be presented on display 4 and/or audibly from speakers 13.

Referring back to block 302, if the vehicle user does not have an aggregated calendar and/or to-do list, the vehicle user may be able to create an aggregated calendar and/or to-do list (block 308). If the vehicle user does not create a calendar and/or to-do list, a flag may be set indicating that the vehicle user does not have an aggregated calendar and/or to do list (block 310). In some embodiments, notifications may be periodically generated and presented by the application 102 to the vehicle user that an aggregate calendar and/or tasks has not been created. In this case, periodically may refer to daily, weekly, monthly, and/or yearly. Additionally or alternatively, the notifications may be generated with every activation of the application 102.

Referring to block 320, if the vehicle user has customized the calendar and/or tasks, such preferences may be received/loaded by the application 102. As represented in block 322, the non-aggregated calendar and/or to-do list may be presented at the VCS 1.

Where the vehicle user seeks to create an aggregated calendar and/or to-do list, a command or input may be received at the VCS 1 for an aggregated calendar and/or to-do list to be created. The command or input may be a voice-based command and/or a tactile (e.g., touch-sensitive) command. In some embodiments, the command(s) may include one or more contacts of the vehicle user's to identify which calendars and/or tasks to aggregate with the vehicle user's.

Instructions may be transmitted from the application 102 to the third-party service 112 to search the vehicle user's contacts (block 312). The contacts may be personal and/or professional. One or more identified contacts may be included in the command(s) received at the VCS 1 (block 314). Alternatively, the contact(s) from the third-party service 112 may be received and presented at the VCS 1 and the user may identify the contact(s) through verbal and/or touch-sensitive selection at the VCS 1. By identifying and selecting the contact(s), aggregation with the contact's calendar and/or task data may be automatically permitted. In some instances, permission may be given to the vehicle user to aggregate with the contact's calendar and/or tasks.

The calendar and/or task information may be received (block 316) and data aggregation may be performed by the third-party service 112 or the application 102 (block 318). Further, the aggregated calendar and/or tasks may be customized by the application 102 according to the vehicle user's preferences (block 320). After the calendar and/or tasks has been aggregated and customized (if there are customization), the aggregated calendar and/or tasks may be presented from the VCS 1 (block 322).

Referring back to block 304, the same process as described above may be performed if the vehicle user's modifies the aggregated calendar and/or tasks.

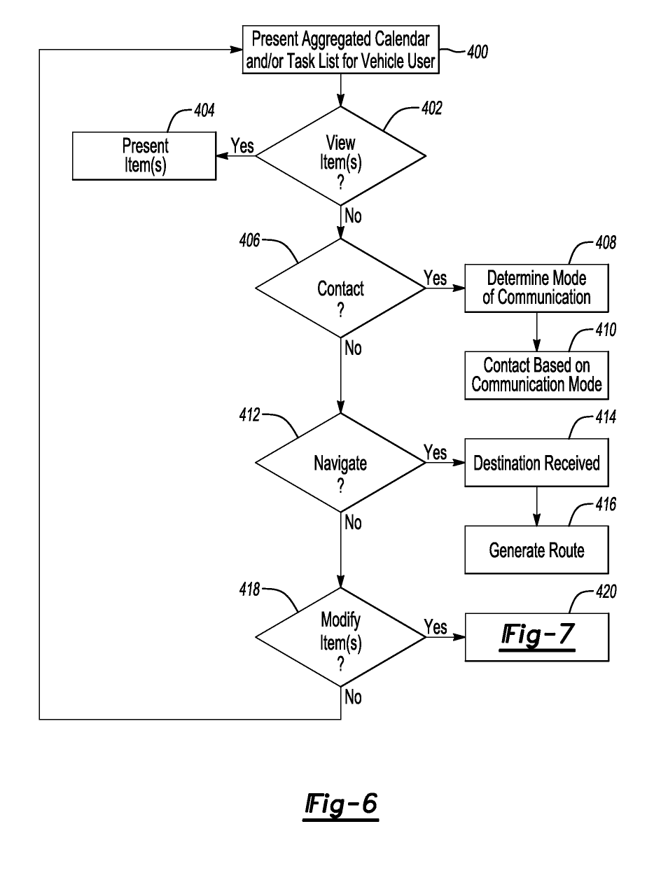

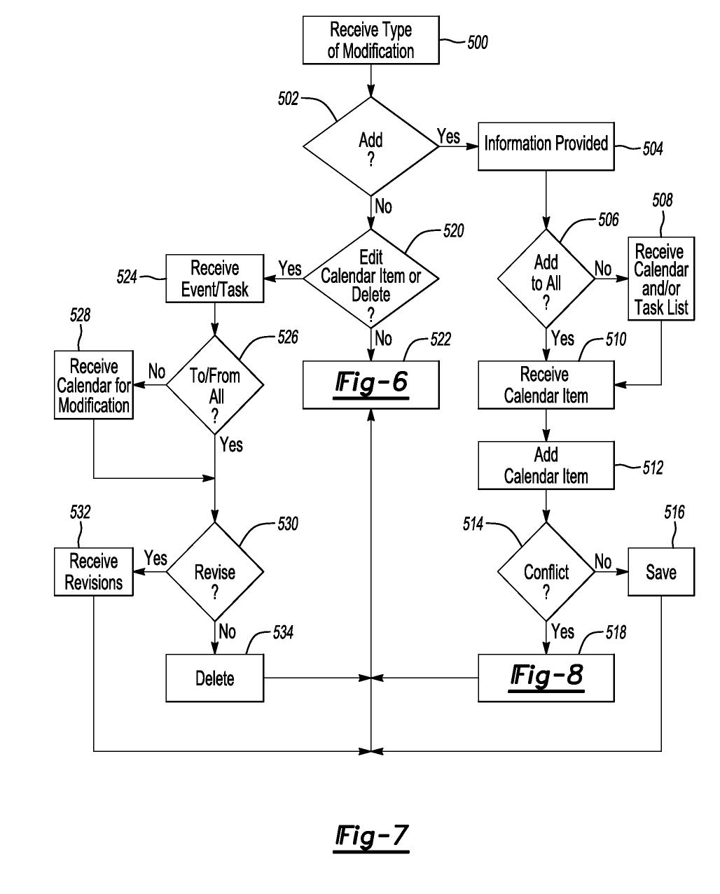

FIG. 6 illustrates a process for operating the aggregated calendar and/or tasks. Of course, the process in FIG. 6 is not limited to the use of an aggregated calendar and/or to-do list. The vehicle user may alternatively use/operate a non-aggregated calendar and/or to-do list from the VCS 1 in a similar manner.

The aggregated calendar and/or tasks may be presented at the VCS 1 (block 400). The vehicle user may view personal schedules and tasks and/or the schedules and tasks of the aggregated contacts if included in the aggregated calendar and/or to-do list (block 402). The schedules and/or tasks may be presented at the VCS 1 (block 404).

In some embodiments, unrestricted users may be presented with calendar and/or task information for all vehicle users. For example, the unrestricted user may view their aggregated calendar and/or tasks and the personal and/or aggregated calendars and/or to-do list of other vehicle users. In some embodiments, the unrestricted user may additionally view the calendar and/or task items of other vehicle users' aggregated contacts if the unrestricted user and the other vehicle users' aggregated contacts are contacts. For example, if another vehicle user has an aggregated calendar with contact A, B and C, the unrestricted user may view the aggregated calendar and tasks of these contacts and may view the calendar and/or task items of contacts A and C if such contacts are also contacts of the unrestricted user's.

Further, restricted users may be presented with personal calendars and/or tasks and their own aggregated calendar and/or tasks. Unlike for unrestricted users, personal and/or aggregated calendars and/or tasks for other vehicle users may not be presented to a restricted user.

The vehicle user may also (or alternatively) contact one or more contacts if an item includes identification and/or contact information for one or more contacts (block 406) such as (and without limitation) a name, phone number, email address, or a combination of such information. A mode of communication may be determined (block 408) based on vehicle user instructions for the mode of communication which may be provided through verbal and/or touch-sensitive command(s). In some embodiments, the mode of communication may be selected via a link (or other input) in the item. In some cases, the mode of communication may be a default based on the vehicle user's preference (which may be predetermined as described above). Non-limiting examples of such modes of communication include e-mail, phone, text, and the like. Contact may be made (or attempted) based on the mode of communication (block 410).

The vehicle user may also (or alternatively) be navigated to a destination where an item includes destination information (block 412). The destination information may be, without limitation, an address, a point-of-interest, a cross-street, or other like destination information. Instructions may be received by the navigation system 60 to navigate to the destination based on verbal and/or touch-sensitive commands from the vehicle user. Accordingly, the destination may be received (block 414) and the route generated (block 416) by the navigation system 60.

In some embodiments, the vehicle user may be provided with an estimated time of arrival to the destination based on the navigation information. Additionally or alternatively, this estimated time of arrival may be used to inform, for example, other attendees of a meeting or event (who may or may not be contacts in the aggregated calendar) of the vehicle user's arrival time. The event attendees may be informed using a mode of communication described above. In some embodiments, the mode of communication may be limited based on the number of event attendees. For example, if there are 1-2 attendees, the vehicle user may use phone, e-mail, or text to provide the arrival information. If there are more than two attendees, the vehicle user may contact the attendees using e-mail or text (e.g., for purposes of efficiency). Of course, the values, limits, and combinations of modes of communication are non-limiting and may be modified according to the particular implementation of the invention.

The calendar and/or task items may also (or alternatively) be modified at the VCS 1 (block 418). Modifying calendar and/or task item(s) may include, but is not limited to, cancellations, postponement, adding/deleting calendar items, adding/deleting appointment attendees/invitees, revising calendar item content, and the like. The calendar and/or task item modification item will be described below with respect to FIG. 7 (block 420).

If the vehicle user does not operate the application 102, the aggregated calendar may be presented until one or more commands/instructions are received (block 400).

FIG. 7 illustrates a process for modifying items in an aggregated calendar and/or to-do list. Without limitation, the items are referred to as “calendar items” in FIG. 7. The application 102 may receive the modification the vehicle user seeks based on one or more verbal and/or touch-sensitive commands (block 500).

As shown in block 502, a calendar item may be added. The vehicle user may input information for the calendar item (e.g., tasks, places, meeting attendees, times, etc.) and the information received by the application 102 (block 504). The information may be provided by the vehicle user using free-form text, natural language, predetermined commands (touch-sensitive and/or verbal), or a combination of such methods.

The vehicle user may add calendar items to select calendars (e.g., of the vehicle user's and/or of the one or more contacts) in the aggregated calendar or to all calendars in the aggregated calendar (block 506). When adding calendar item(s) to select calendars, the calendar(s) may be identified (block 508) using verbal and/or touch-sensitive input.

To add calendar item(s) to all or select calendars, the calendar item(s), once generated by the vehicle user, may be received (e.g., in response to user input) by the application 102 (block 510). The calendar item(s) may be then added to the calendar(s) (block 512).

As a non-limiting example, in a family aggregated calendar including the vehicle user and the vehicle user's spouse and children, the vehicle user may want to schedule happy hour for the vehicle user and user's spouse (thereby excluding the children). Accordingly, the vehicle user may generate the calendar item and instruct that the item be added to the spouse's schedule. Later, the vehicle user may want to schedule a family dinner. Accordingly, the vehicle user may generate the calendar item for the family dinner and instruct that the item be added to all calendars.

As another non-limiting example, a vehicle user may aggregate personal and professional calendars. The calendars may be given identifiers (e.g., a name) to identify the different calendars. Accordingly, the vehicle user may desire to add certain events to all calendars (personal and professional) and other events to select calendars.

In some embodiments, a default may be set to add a calendar item to all or select calendars unless otherwise instructed by the vehicle user.

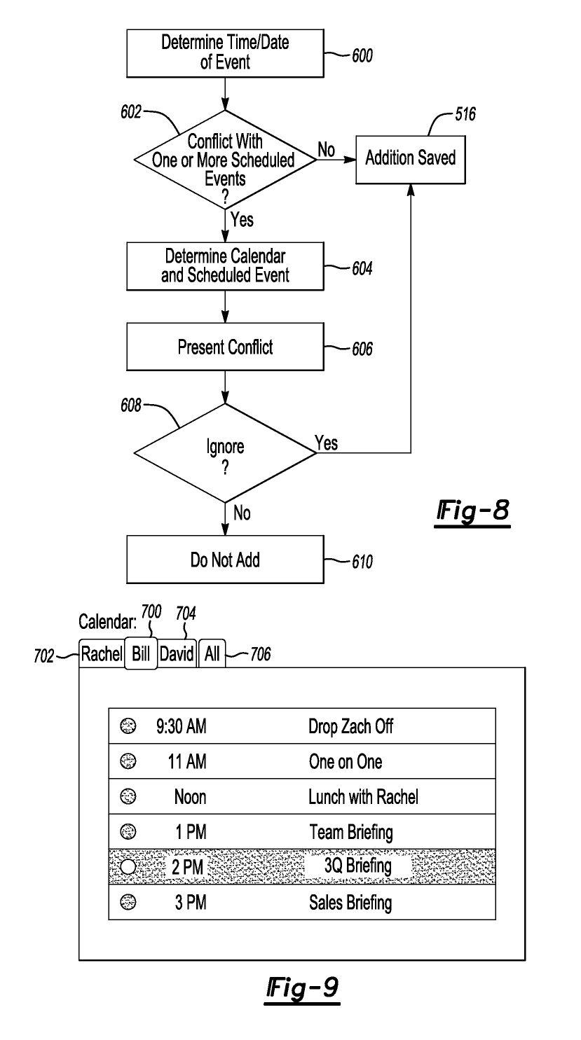

When adding calendar items, the vehicle user may be presented with conflicts in the user's personal schedule or the schedule of a contact's (block 514). If there are no conflicts, the added calendar item may be saved to the calendars (block 516). In the case that there are conflicts, however, the vehicle user may be notified as described with respect to FIG. 8 below (block 518). In either case, the aggregated calendar may then be presented (block 522) or otherwise operated as illustrated in FIG. 6.

In some embodiments, the vehicle user may arrange to receive notifications regarding a contact's schedule. For example, notifications may be receive for updates to the contact's calendar (e.g., any modifications to the contact's calendar). Accordingly, vehicle users may plan ahead whether to add calendar items to a contact's schedule as a result of the notification that the contact's calendar has been updated. The notification(s) may be sent in an e-mail, text message, or other like communication. The vehicle user may opt to receive the notification as part of the vehicle user's preferences/customizations.

Referring to FIG. 8, the time and/or date of the calendar item may be determined from the information provided by the vehicle user (block 600). Using the time and/or date information, the other calendar(s) of the aggregated calendar may be searched for conflicts (block 602). If no conflicts exist, the addition may be saved (block 604, corresponding to block 516 of FIG. 7). If a conflict exists, the calendar with the conflict event(s) (e.g., the vehicle user's and/or a contact's) may be identified along with the conflicting event (block 604). The conflicting calendar and event may be presented at the VCS 1 (block 606).

In some instances, the user may ignore the conflict (block 608). If the user does ignore the conflict, the calendar item may be added to the calendar(s). Otherwise, the calendar item is not added (block 610). In some embodiments, the vehicle user may be additionally presented with alternate times and/or dates to add the calendar item.

Referring back to FIG. 7, calendar items may additionally or alternatively be edited and/or deleted (block 520). If the calendar item is not edited and/or deleted, the aggregated calendar may be presented (block 522) or otherwise operated as illustrated in FIG. 6.

In the case where a calendar item is to be edited and/or deleted, the calendar item may be received (e.g., in response to user input) by the application 102 (block 524). As a non-limiting example, the vehicle user may identify (e.g., by a verbal and/or touch-sensitive input) a calendar item scheduled on the calendar presented at the VCS 1. Once the calendar item is identified, the change and/or deletion may be applied to all calendars in the aggregated calendar or to select calendars (block 526). In the case where calendar items are revised/deleted from select calendars, such calendar(s) may be identified using verbal and/or touch-sensitive input (block 528).

If a calendar item is to be revised (block 530), the revisions to the calendar item may be received by the application 102 (block 532). Non-limiting examples of revisions may including postponing or cancelling an event, revising calendar item content, revising a scheduled venue, and adding/removing meeting attendees. Other non-limiting examples are described above. The revisions may be provided by the vehicle user.

If there are no revisions to the calendar item, the identified calendar item may be deleted (block 534).

The aggregated calendar may then be presented and/or otherwise operated as described with respect to FIG. 6.

While exemplary embodiments are illustrated and described above, it is not intended that these embodiments illustrate and describe all possibilities. Rather, the words used in the specification are words of description rather than limitation, and it is understood that various changes may be made without departing from the spirit and scope of the invention.

What is claimed is:

1. A computer-implemented method for using and managing an electronic calendar in a vehicle, the method comprising:
receiving information at a vehicle computer identifying at least one vehicle occupant;
receiving at a computer electronic calendar data including at least two electronic calendars each associated with (1) the at least one vehicle occupant and (2) at least one contact of the at least one vehicle occupant; and
displaying within the vehicle the electronic calendar for the identified vehicle occupant and the contact of the vehicle occupant.

2. The computer-implemented method of claim 1 further comprising displaying the electronic calendar for the vehicle occupant in a first window and the electronic calendar for the contact of the vehicle occupant in a second window.

3. The computer-implemented method of claim 2 wherein the first and second windows are aggregated in an aggregated electronic calendar.

4. The computer-implemented method of claim 3 wherein the aggregated electronic calendar includes tabs for selecting the first and second windows.

5. The computer-implemented method of claim 3 further comprising instructing the electronic calendar to display the first window as a default when executing within the vehicle.

6. The computer-implemented method of claim 1 further comprising identifying the vehicle occupant as a driver or a passenger.

7. The computer-implemented method of claim 1 further comprising:
receiving one or more instructions at the vehicle computer defining one or more operations to be performed on the electronic calendar;
based on the instructions, determining for which of the at least two electronic calendars to perform the one or more operations; and
performing the one or more operations for at least one of the at least two electronic calendars.

8. The computer-implemented method of claim 1 further comprising receiving the identifying information from at least one vehicle occupant identification source selected from a vehicle key, a paired nomadic device, voice recognition, or a vehicle occupant associated code.

9. The computer-implemented method of claim 8 further comprising receiving the identifying information from at least two of the identification sources.

10. A system for using and managing an electronic calendar in a vehicle, the system comprising:
at least one vehicle computer configured to:
receive electronic calendar data including at least two electronic calendars, at least one of which is associated with at least one vehicle occupant;
receive one or more instructions to perform one or more calendar operations selected from adding, deleting, or revising one or more calendar items of at least one of the at least two electronic calendars;
receive information identifying for which of the at least two electronic calendars to perform the one or more calendar operations; and
perform the one or more calendar operations on the one or more calendar items of at least one of the at least two electronic calendars.

11. The system of claim 10 wherein the at least two electronic calendars are associated with the at least one vehicle occupant.

12. The system of claim 10 wherein the at least two electronic calendars are each associated with (1) at least one vehicle occupant and (2) at least one contact of the at least one vehicle occupant.

13. The system of claim 10 wherein the at least one vehicle computer is further configured to:
receive information identifying the at least one vehicle occupant; and
display the electronic calendar for the identified vehicle occupant.

14. The system of claim 13 wherein the vehicle computer is further configured to audibly output the one or more calendar items of the electronic calendar.

15. The system of claim 13 wherein the vehicle computer is further configured to receive the identifying information from at least one vehicle occupant identification source selected from a vehicle key, a paired nomadic device, voice recognition, or a vehicle occupant associated code.

16. The system of claim 15 wherein the vehicle computer is further configured to receive the identifying information from at least two of the identification sources.

17. The system of claim 10 wherein the at least two electronic calendars comprise a first electronic calendar and a second electronic calendar, the vehicle computer being further configured to output a conflict notification for at least one calendar item with at least one other calendar item in the second electronic calendar.

18. The system of claim 17 wherein the at least one vehicle computer is further configured to output the conflict notification when adding one or more calendar items.

19. The system of claim 10 wherein the vehicle computer is further configured to receive one or more audible commands including the information identifying for which electronic calendar to perform the calendar operation.

20. The system of claim 19 wherein the identifying information includes at least one electronic calendar or all electronic calendars.

21. A computer-program product on a computer-readable medium programmed for using and managing an electronic calendar in a vehicle and comprising instructions for:
receiving information identifying a vehicle occupant;
receiving electronic calendar data including at least two electronic calendars, at least one of which is associated with the identified vehicle occupant; and
outputting the at least two electronic calendars at a vehicle computer.

22. The computer-program product of claim 21 further comprising instructions for identifying the vehicle occupant as a driver or a passenger.

23. The computer-program product of claim 22 further comprising instructions for providing selective control of vehicle controls based on whether the vehicle occupant is a driver or a passenger.

24. The computer-program product of claim 21 wherein at least one of the at least two electronic calendars is associated with a contact of the vehicle occupant.

25. The computer-program product of claim 24 wherein the contact is a family member or co-worker.

26. The computer-program product of claim 21 wherein the at least two calendars are different calendars for the identified vehicle occupant.

27. The computer-program product of claim 21 wherein the vehicle occupant may be an unrestricted calendar user or a restricted calendar user as defined by the operation privileges for the at least two electronic calendars.
